(19) United States
(12) Patent Application Publication
(10) Pub. No.: US 2025/0340042 A1
(43) Pub. Date: Nov. 6, 2025

(54) SYNTHETIC RESIN LEATHER AND METHOD FOR MANUFACTURING SAME

(71) Applicant: OKAMOTO INDUSTRIES, INC., Tokyo (JP)

(72) Inventors: Hironori KOBAYASHI, Tokyo (JP); Naoto MATSUMOTO, Tokyo (JP); Shin NAKAYA, Tokyo (JP); Yoritaka ASADA, Tokyo (JP)

(73) Assignee: OKAMOTO INDUSTRIES, INC., Tokyo (JP)

(21) Appl. No.: 18/855,482

(22) PCT Filed: Jul. 19, 2023
(86) PCT No.: PCT/JP2023/026338

§ 371 Date: Oct. 9, 2024

(30) Foreign Application Priority Data
Jul. 28, 2022 (JP) 2022-120092

(51) Int. Cl. B32B 3/30; B32B 5/02; B32B 27/12; B32B 27/30; B32B 37/20; B32B 38/06

(52) U.S. Cl. CPC B32B 3/30; B32B 5/02; B32B 27/12; B32B 27/304; B32B 37/203; B32B 38/06; B32B 2250/02; B32B 2305/18; B32B 2307/51; B32B 2307/584; B32B 2327/06

(57) ABSTRACT

Provided is a synthetic resin leather that provides a smooth satisfactory touch feeling like a natural leather and has excellent pressure resistance. The synthetic resin leather includes: a base material; and a skin layer that is stacked on the base material and is made of an elastically deformable synthetic resin, wherein a large number of micro protrusions is intermittently and regularly provided on a surface of the skin layer, and the large number of micro protrusions include a large number of top surface parts that are formed at substantially a same height from the surface of the skin layer and a large number of pillar sections that are formed to be elastically deformable from the surface of the skin layer over the large number of top surface parts.

### TECHNICAL FIELD

The present invention relates to a synthetic resin leather used as a vehicle interior material for an automobile or the like, upholstery for a chair, a sofa, or the like, a shoes upper material, or a skin material for stationery such as a planner notebook or a smartphone case, and a method of manufacturing such an article.

### BACKGROUND ART

In the related art, as this kind of synthetic resin leather, there have been a synthetic resin skin material having a surface on which an emboss pattern, which is a leather-like fine uneven pattern, is formed by pressing an emboss roll with the emboss pattern carved thereon against a skin layer containing a vinyl chloride resin as a main component on a base fabric in a state where the surface of the emboss roll is heated and a method of manufacturing the same (see PTL 1, for example).

Also, there have been a leather-like sheet with a nubuck tone appearance obtained by applying unevenness to a surface of a sheet material through embossing using an embossing roll or the like and then performing napping using a sandpaper, a brush, or the like, and a method of manufacturing the same (see PTL 2, for example).

### CITATION LIST

### Patent Literature

[PTL 1] Japanese Patent Application Publication No. 2020-111024
[PTL 2] Japanese Patent Application Publication No. H8-060557

### SUMMARY OF INVENTION

### Problem to be Solved by Invention

However, PTL 1 as described above has a problem that since projecting portions in the fine uneven pattern formed through the embossing cannot be elastically deformed and are successively arranged, and tips of the projecting portions do not move at all even if a user touches the fine uneven pattern with his/her hand or fingers, an entirely planer and flat feeling or a rubber-like feeling such as a feeling of stickiness like rubber is thus strongly given, it is not possible to obtain a smooth feeling like a feeling from a natural leather, and a feeling of discomfort as compared with a natural leather is given.

PTL 2 has a problem that since the surface finely napped with the sandpaper or the like is excessively deformed due to contact of a user's hand, fingers, or the like, shape retention properties based on pressure resistance and abrasion resistance is poor, it is difficult to use the leather-like sheet for a seat surface that requires especially high pressure resistance and abrasion resistance, hence, applications are limited.

Under such circumstances, a synthetic resin leather has been required that provides a satisfactory touch feeling similar to that from a natural leather and has excellent pressure resistance and abrasion resistance.

### Solution to Problem

In order to solve such a problem, a synthetic resin leather according to the present invention includes: a base material; and a skin layer that is stacked on the base material and is made of elastically deformable synthetic resin, wherein a large number of micro protrusions is intermittently and regularly provided on a surface of the skin layer, and the large number of micro protrusions include a large number of top surface parts that are formed at substantially same height from the surface of the skin layer and a large number of pillar sections that are formed to be elastically deformable from the surface of the skin layer over the large number of top surface parts.

Also, in order to solve such a problem, a method of manufacturing a synthetic resin leather according to the present invention includes: a stacking step of providing a skin layer that is made of an elastically deformable synthetic resin on a base material; and an embossing step of intermittently and regularly providing a large number of micro protrusions over an entire surface of the skin layer, wherein in the embossing step, a large number of top surface parts that are formed at substantially same height from the surface of the skin layer and a large number of pillar sections that are formed to be elastically deformed from the surface of the skin layer over the large number of top surface parts are embossed as the large number of micro protrusions.

Here, “substantially the same height” means that most of the top surface parts are at completely the same (identical) height, and also includes a meaning that all the top surface parts are at the identical height and a meaning that some of the top surface parts are at slightly different heights.

### BRIEF DESCRIPTION OF DRAWINGS

FIG. 1 is an explanatory diagram illustrating overall configurations of a synthetic resin leather and a method of manufacturing the synthetic resin leather according to an embodiment (first embodiment) of the present invention, where FIG. 1 at (a) is a front vertical sectional view illustrating main components in a partially enlarged manner, and FIG. 1 at (b) is a side view illustrating the method of manufacturing the synthetic resin leather in a reduced size.

FIG. 2 is an explanatory diagram illustrating an example of micro protrusions, where FIG. 2 at (a) is an enlarged photo of an aligned state, and FIG. 2 at (b) is a further enlarged photo.

FIG. 3 is an explanatory diagram illustrating a modification of the micro protrusions, where FIG. 3 at (a) is an enlarged photo of the aligned state, and FIG. 3 at (b) is a further enlarged photo.

FIG. 4 is an explanatory diagram (a front vertical sectional view illustrating main components in a partially enlarged manner) of a synthetic resin leather according to an embodiment (second embodiment) of the present invention.

### DESCRIPTION OF EMBODIMENTS

Hereinafter, embodiments of the present invention will be described in detail on the basis of the drawings.

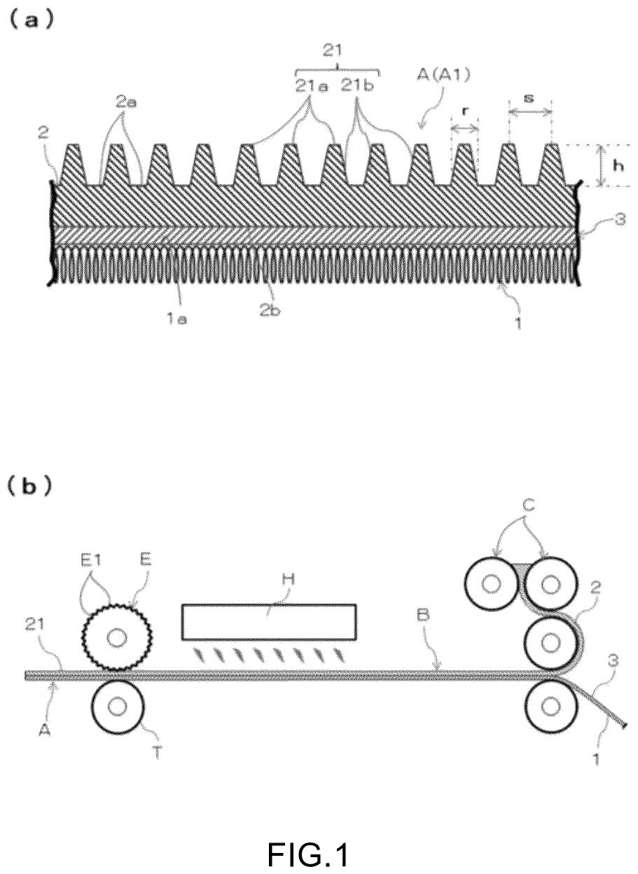

A synthetic resin leather A according to an embodiment of the present invention is a synthetic leather or an artificial leather that is used as a vehicle interior material for an automobile or the like, upholstery for a chair, a sofa, or the like, a shoes upper material, or a skin material for stationery such as a planner notebook or a smartphone case. Among such synthetic leathers and artificial leathers, there is a synthetic resin leather A obtained by applying a fine emboss pattern to a skin layer 2 provided on a base material 1 through embossing as illustrated in FIGS. 1 to 4.

More specifically, the synthetic resin leather A according to the embodiment of the present invention includes, as main components, the base material 1 on a rear side and the skin layer 2 on a front side as illustrated in FIGS. 1 at (a) and 4.

Furthermore, an underlayer 3 that is provided between the base material 1 and the skin layer 2 is preferably included.

The base material 1 is a fabric such as a woven fabric, knitted work, or a non-woven fabric and preferably gives strength and an appropriate thickness without losing flexibility of the skin layer 2, which will be described later.

As a material of the base material 1, fiber made of an olefin-based resin such as polyester fiber, rayon, polyvinyl chloride (PVC), or polypropylene, polyester fiber, polyamide fiber, acryl fiber, cotton, rayon, a blend yarn thereof, or the like is used.

Also, it is possible to use a soft foam sheet or an integral stack of the fabric and the soft foam sheet as the base material 1.

The base material 1 is preferably formed by stacking the underlayer 3 on a front side surface 1a of the base material 1.

The underlayer 3 is an adhesive layer that establishes adhesion between the front side surface 1a of the base material 1 and a rear surface 2b of the skin layer 2, which will be described later, and a polyvinyl chloride paste, an ethylene-vinyl acetate copolymer-based emulsion, a two-component polyurethane adhesive, or the like is used.

Furthermore, the underlayer 3 is preferably stacked between the front side surface 1a of the base material 1 and the rear surface 2b of the skin layer 2 by an adhesive being applied to the front side surface 1a of the base material 1 or by an adhesive being applied to the rear surface 2b of the skin layer 2.

Also, although not illustrated as another example, it is also possible to cause a soft foam sheet such as polypropylene foam to be interposed between the front side surface 1a of the base material 1 and the rear surface 2b of the skin layer 2.

The skin layer 2 is made of a thermoplastic resin that is elastically deformable, has flexibility, and has low hardness, such as soft polyvinyl chloride (PVC), thermoplastic polyurethane, acrylic soft resin, copolymer polyester, or a partially crosslinked polyolefin elastomer and preferably contains soft polyvinyl chloride as a main component in particular.

Each of a large number of micro protrusions 21 are intermittently (discontinuously) provided in a separated manner on a surface 2a of the skin layer 2, and the large number of micro protrusions 21 are regularly arranged along the surface 2a of the skin layer 2.

The micro protrusions 21 are micro dots with micron sizes embossed over the entire surface 2a of the skin layer 2 through embossing using an emboss plate. An emboss roll E is preferably used as the embossing plate, and an emboss pattern E1 is carved on a plate surface of the emboss roll E facing the surface 2a of the skin layer 2 by any one of or a combination of some of laser working, etching, milling, and sand blasting. As the emboss pattern E1, at least a large number of fine recess parts (not illustrated) corresponding to the large number of micro protrusions 21 are intermittently and regularly provided substantially over the entire plate surface. Furthermore, it is also possible to carve design recessed portions (not illustrated) such as a specific pattern as another emboss pattern E1 in combination.

Furthermore, the micro protrusions 21 include top surface parts 21a that are formed at substantially the same height from the surface 2a of the skin layer 2 and pillar sections 21b that are formed to be elastically deformable from the surface 2a of the skin layer 2 to the top surface parts 21a.

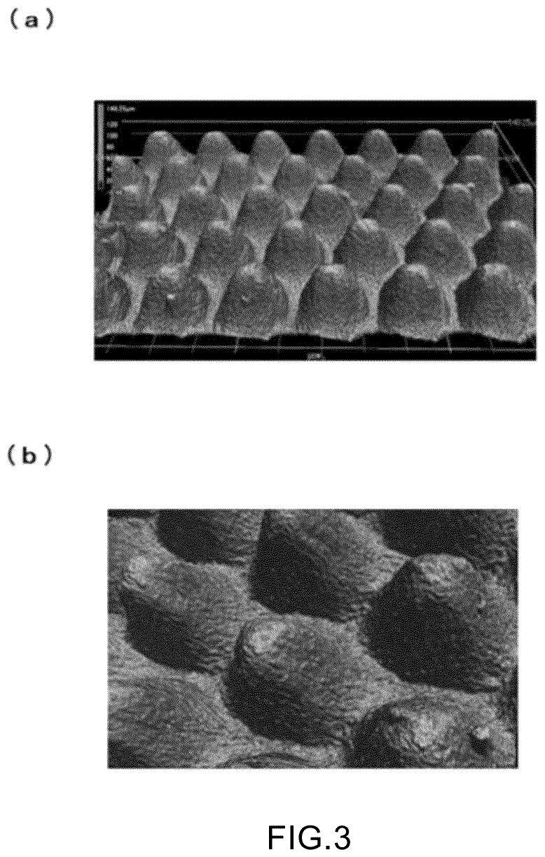

The micro protrusions 21 are formed into a prism shape or a semispherical shape (helmet shape), and the top surface parts 21a have a planar shape as illustrated in FIGS. 1 at (a), 2 at (a), and 2 at (b) in the case of the prism shape, or the top surface parts 21a have a curved shape as illustrated in FIGS. 3 at (a) and 3 at (b) in the case of the semispherical shape.

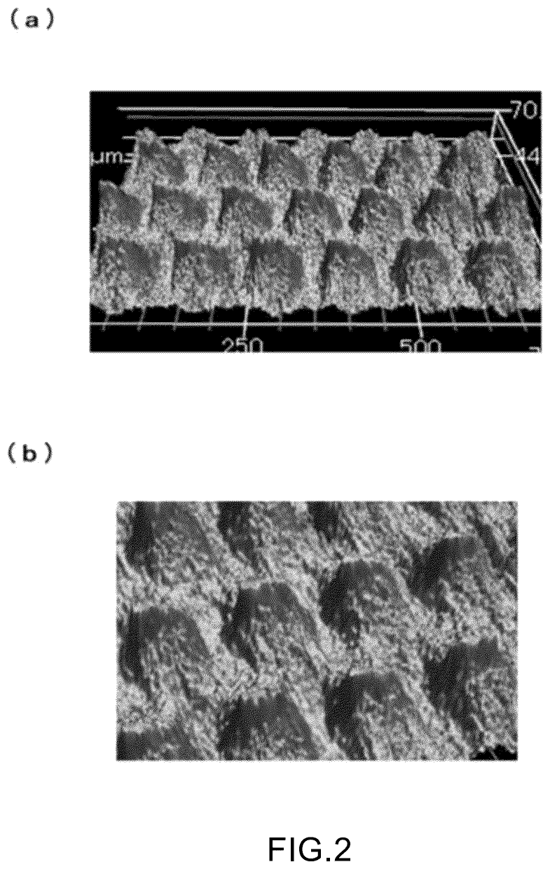

Since the size of the large number of micro protrusions 21 is in units of microns, it is difficult to recognize presence/absence of micro protrusions 21 with the naked eye, and it is not possible to recognize the micro protrusions 21 without enlarging the micro protrusions 21 with a microscope or the like as illustrated in FIGS. 2 at (a), 2 at (b), 3 at (a), and 3 at (b). In a stereoscopic image obtained by a 3D display function of a digital microscope such as a 3D measurement laser microscope as illustrated in FIGS. 2 at (a) and 3 at (a), XY axis scales of a 50 μm pitch are displayed to allow the size of the large number of micro protrusions 21 to be checked, height color display indicating height differences is used, and further, FIGS. 2 at (b) and 3 at (b) display portions in a partially enlarged manner such that a more detailed structure of the large number of micro protrusions 21 can be recognized.

Also, in order to simultaneously obtain a smooth satisfactory touch feeling that is equivalent to that of a natural leather and excellent pressure resistance and abrasion resistance, it is necessary to set the size of each micro protrusion 21, the height of each micro protrusion 21, and the mutual interval between adjacent micro protrusions 21 in a predetermined size balance among the large number of micro protrusions 21.

The size of the micro protrusions 21 corresponds to an average diameter r of the pillar sections 21b on the side of the skin layer 2. The height of each micro protrusion 21 corresponds to an average height h from the surface 2a of the skin layer 2 to the top surface part 21a. The mutual interval between the adjacent micro protrusions 21 corresponds to an average center interval s between adjacent pillar sections 21b.

More specifically, the size (average diameter r) of the micro protrusions 21 is set to 40 μm to 85 μm, is preferably set to 45 μm to 80 μm, and is further preferably set to 50 μm to 75 μm. In a case where the average diameter r of the micro protrusions 21 is less than 40 μm, the top surface parts 21a and the pillar sections 21b have excessively small diameters, an exposure area of the surface 2a of the skin layer 2 except for the micro protrusions 21 relatively increases, and the pillar sections 21b become more likely to be elastically deformed or deformed in a collapsed manner more than necessary, which is unfavorable. On the other hand, in a case where the average diameter r of the micro protrusions 21 is greater than 85 μm, the pillar section 21b has an excessively large diameter, and the pillar sections 21b becomes unlikely to be elastically deformed even when a user's hand, fingers, or the like touches the top surface parts 21a, which is unfavorable.

The height (average height h) of the micro protrusions 21 is set to 40 μm to 200 μm, is preferably set to 50 μm to 165 μm, and is further preferably set to 60 μm to 130 μm. In a case where the average height h of the micro protrusions 21 is less than 40 μm, the top surface parts 21a and the pillar sections 21b become excessively low (relatively thick and short), the top surface parts 21a approach the surface 2a of the skin layer 2 excessively, and the pillar sections 21b become unlikely to be elastically deformed, which is unfavorable. On the other hand, in a case where the average height h of the micro protrusions 21 is higher than 200 μm, the top surface parts 21a and the pillar sections 21b become excessively high (relatively thin and long), and the pillar sections 21b are likely to be deformed in a bended manner due to a load, which is unfavorable.

The mutual intervals (average center interval s) of the adjacent micro protrusions 21 is set to 50 μm to 200 μm, is preferably set to 60 μm to 165 μm, and is further preferably set to 70 μm to 130 μm. In a case where the average center interval s of the micro protrusions 21 is less than 50 μm, the top surface parts 21a and the pillar sections 21b excessively approach each other, the density of the micro protrusions 21 with respect to the surface 2a of the skin layer 2 becomes high, and the pillar sections 21b are unlikely to be elastically deformed even if a user's hand, fingers, or the like touch the top surface parts 21a, which is unfavorable. On the other hand, in a case where the average center interval s of the micro protrusions 21 is greater than 200 μm, the top surface parts 21a and the pillar sections 21b are excessively separated from each other, the density of the micro protrusions 21 with respect to the surface 2a of the skin layer 2 decreases, the exposure area of the surface 2a of the skin layer 2 except for the micro protrusions 21 thus relatively increases, and the pillar sections 21b are likely to be elastically deformed or deformed in a collapsed manner more than necessary, which is unfavorable.

In other words, it is preferable that a relationship of the size (average diameter r), the height (average height h), and the mutual interval (average center interval s) of each of the large number of micro protrusions 21 have the following ratio “average diameter r:average height h:average center interval s” and be in a size balance in which the average center interval s is longer than the average diameter r.

“Average diameter r:average height h:average center interval s=40 μm to 85 μm:40 μm to 200 μm:50 μm to 200 μm=about 2.0 to 4.3:about 2.0 to 10.0:about 2.5 to 10.0”

In such a size balance, it is possible to achieve a smooth satisfactory touch feeling that is equivalent to that of a natural leather and excellent pressure resistance.

Next, specific examples (first embodiment and second embodiment) of the synthetic resin leather A according to embodiments of the present invention will be described.

In a synthetic resin leather A1 according to the first embodiment illustrated in FIGS. 1 at (a), 2 at (a), 2 at (b), 3 at (a), and 3 at (b), only the large number of micro protrusions 21 are aligned at predetermined intervals or a uniform interval in a staggered shape through embossing achieved by a large number of fine recess parts carved as the emboss pattern E1 of the emboss roll E on the surface 2a of the skin layer 2.

Also, although not illustrated as another example, a change in which each of the large number of micro protrusions 21 is aligned at predetermined intervals or at a uniform interval in a lattice shape (grid shape) or the like can be made.

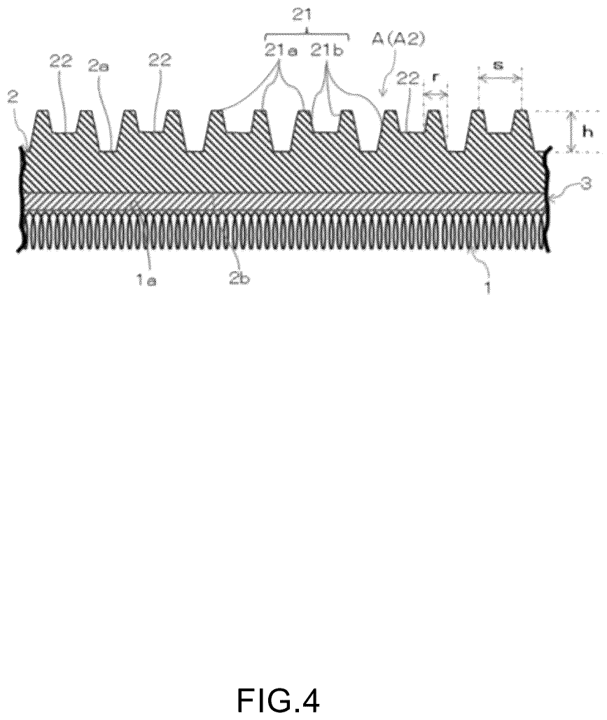

In a synthetic resin leather A2 according to the second embodiment illustrated in FIG. 4, a designed surface 22 such as a cloud pattern, for example, is arranged in addition to the regular arrangement of the large number of micro protrusions 21 through embossing achieved by a large number of fine recess parts and design recess parts carved as the emboss pattern E1 of the emboss roll E on the surface 2a of the skin layer 2. In this case, it is possible to improve a design property as compared with the first embodiment.

Also, although not illustrated as another example, it is also possible to change the shape to a shape other than the illustrated example in order to obtain the height of the designed surface 22 as a desired pattern.

Furthermore, it is also possible to adjust to an excellent abrasion resistance, glossiness, and the like by a surface treated layer (not illustrated) being formed on the surface 2a of the skin layer 2 to cover the large number of micro protrusions 21 as needed. As a material of the surface treated layer, a urethane resin, an acrylic resin, or the like is used, and the surface treated layer is formed by applying the material with a uniform thickness to the surface 2a of the skin layer 2. The thickness of the surface treated layer is 1 μm to 30 μm and is preferably 10 μm to 15 μm.

### [Manufacturing Method]

A manufacturing method for producing the synthetic resin leather A according to the embodiments of the present invention includes, as main steps, a stacking step of providing the skin layer 2 on the base material 1 and an embossing step of regularly providing the large number of micro protrusions 21 over the entire surface 2a of the skin layer 2 as illustrated in FIG. 1 at (b).

In the stacking step, the rear surface 2b of the skin layer 2 is caused to adhere to the front side surface 1a of the base material 1 via the underlayer 3 through calender molding, extrusion molding, or the like.

In the embossing step, each of the large number of micro protrusions 21, the designed surface 22, and the like is intermittently and regularly applied to the surface 2a of the skin layer 2 over the entire surface 2a through embossing using the emboss roll E.

Also, in a case where the surface treated layer covering the large number of micro protrusions 21 is formed on the surface 2a of the skin layer 2, it is preferable to apply a urethane resin that serves as a material of the surface treated layer to the surface 2a of the skin layer 2 at a timing at least before the embossing step.

In the case illustrated in FIG. 1 at (b) as a specific example of the method of manufacturing the synthetic resin leather A, the embossing step is performed after the stacking step.

Specifically, the front side surface 1a of the base material 1 is stacked on the rear surface 2b of the skin layer 2 rolled into a predetermined thickness by a calender molding machine C via the underlayer 3, and a front surface side of a stacked body B is heated by a heater H. Subsequently, the stacked body B is inserted between the emboss roll E and a touch roll T, and the large number of micro protrusions 21 are transferred to the surface 2a of the skin layer 2.

In this case, since the thicknesses of the underlayer 3 and the base material 1 are added to the thickness of the skin layer 2 in the previously performed stacking step, and the entire thickness thus increases, it is possible to deeply transfer the embossed portions (the large number of micro protrusions 21) by the emboss roll E, which is favorable.

Also, although not illustrated as another example, it is possible to add a change such as separately performing the rolling of the skin layer 2 by the calender molding machine C and the stacking of the base material 1 with intervention of the underlayer 3, stacking the base material 1 with intervention of the underlayer 3 after the transferring of the large number of micro protrusions 21 to the surface 2a of the skin layer 2, and the like.

According to the synthetic resin leather A and the method of manufacturing the same of the embodiments of the present invention as described above, some pillar sections 21b are elastically deformed, and the top surface parts 21a move (minutely move) due to contact of a hand, fingers, or the like by the user's hand, fingers, or the like touching the large number of micro protrusions 21 each intermittently and regularly provided over the surface 2a of the elastically deformable skin layer 2. Subsequently, the pillar sections 21b that have been elastically deformed and the top surface parts 21a that have moved (minutely moved) due to the contact restore the shapes before the contact by the hand, the fingers, or the like being separated from the large number of micro protrusions 21. Therefore, the surface 2a of the skin layer 2 becomes stereoscopic as a whole with the large number of micro protrusions 21 that can minutely move, a sticky feeling is eliminated, and the surface 2a is finished with a smooth tone at the same level as that of a natural leather. Also, since the elastic deformation of the pillar sections 21b and the movement (minute movement) of the top surface parts 21a are effortlessly repeated even if the hand, the fingers, or the like repeatedly contact such large number of micro protrusions 21, plastic deformation is unlikely to occur.

Therefore, it is possible to provide the synthetic resin leather A that provides a smooth satisfactory touch feeling like a natural leather and excellent pressure resistance.

As a result, an entirely planar and flat feeling and a rubber-like feeling such as a feeling of stickiness like rubber are eliminated as compared with a conventional one in which projecting portions are not elastically deformable and are continuously arranged in a fine uneven pattern obtained by embossing, and it is possible to obtain a satisfactory feeling like one from a smooth tone fabric (upholstery for a chair, a sofa, or the like). Also, excessive deformation due to contact with user's hand, fingers, or the like is avoided as compared with the conventional one that has finely napped surface obtained by sandpaper or the like, and utilization for a seat surface that requires especially high pressure resistance is possible.

Therefore, it is possible to improve quality, a feeling of discomfort is not given as compared with a natural leather, and it is possible to use the synthetic resin leather as an alternative of the natural leather in many fields, which is excellent in convenience.

In particular, the large number of micro protrusions 21 are preferably formed into prism shapes in which a large number of top surface parts 21a have planar shapes as illustrated in FIGS. 1 at (a), 2 at (a), and 2 at (b) or semispherical shapes in which the large number of top surface parts 21a have curved shapes as illustrated in FIGS. 3 at (a) and 3 at (b).

In this case, the hand, the fingers, or the like are brought into surface contact with the large number of top surface parts 21a made of an elastically deformable synthetic resin, and local plastic deformation is more unlikely to occur even if the contact is repeated.

Therefore, it is possible to further improve pressure resistance of the large number of micro protrusions 21 (top surface parts 21a).

As a result, it is possible to prevent degradation that accompanies long-time utilization. In this manner, a product life time is extended, and cost reduction can be achieved.

Furthermore, it is preferable that the ratio of the size (average diameter r), the height (average height h), and the mutual interval (average center interval s) of the large number of micro protrusions 21 be set to 40 μm to 85 μm (about 2.0 to 4.3):40 μm to 200 μm (about 2.0 to 10.0):50 μm to 200 μm (about 2.5 to 10.0), and the mutual interval (average center interval s) be set to be longer than the size (average diameter r).

In this case, an arrangement balance is achieved such that the elastic deformation of the pillar sections 21b and the movement (minute movement) of the top surface parts 21a achieved by the user's hand, fingers, or the like touching the large number of micro protrusions 21 and restoring deformation of the pillar sections 21b and the minute restoring movement of the top surface parts 21a achieved by the hand, the fingers, or the like being separated from the large number of micro protrusions 21 are smoothly performed.

Therefore, it is possible to reliably achieve a smooth satisfactory touch feeling like a natural leather and pressure resistance.

As a result, it is possible to obtain the synthetic resin leather A that is ideal as an alternative of the natural leather.

### EXAMPLES

Hereinafter, examples of the present invention will be described.

### Examples 1 to 6 and Comparative Examples 1 to 7

Examples 1 to 6 shown in Table 1 and Comparative Examples 1 to 7 shown in Table 2 are synthetic resin leathers obtained by producing emboss plates (emboss rolls) on which a large number of fine recess parts corresponding to micro protrusions with the sizes (average diameters), the heights (average heights), and mutual intervals (average center intervals) described in the tables are carved and transferring the large number of micro protrusions onto surfaces of skin layers, which are surfaces of skin layers containing soft polyvinyl chloride as a main component, through embossing using the emboss rolls. Also, each of evaluation samples with the same size was produced.

In Examples 1 to 6 and Comparative Examples 1 to 6, the large number of micro protrusions with prism shapes having planar top surface parts were intermittently and regularly (at a uniform interval in a staggered shape) aligned on the surfaces of the skin layers, and underlayers were stacked on the rear surfaces of the skin layers via underlayers, and the examples had a common configuration as illustrated in FIGS. 1 at (a), 2 at (a) and 2 at (b). Comparative Example 7 was different from Examples 1 to 6 and Comparative Examples 1 to 6 in that each of the large number of micro protrusions were irregularly (randomly) aligned.

Additionally, each of the evaluation samples in Examples 1 to 6 and Comparative Examples 1 to 6 with a surface treated layer formed on the surface of the skin layer to cover the large number of micro protrusions were also produced.

In Examples 1 to 6, the sizes (average diameters) of the micro protrusions were 40 to 85 μm, the heights (average heights) of the micro protrusions were 40 to 200 μm, and the mutual intervals (average center intervals) of the micro protrusions were 50 to 200 μm.

Specifically, the average diameter was set to 40 μm, the average height was set to 120 μm, and the average center interval was set to 125 μm for the micro protrusions in Example 1.

For the micro protrusions in Example 2, the average diameter was set to 85 μm, the average height was set to 120 μm, and the average center interval was set to 125 μm.

For the micro protrusions in Example 3, the average diameter was set to 62.5 μm, the average height was set to 40 μm, and the average center interval was set to 125 μm.

For the micro protrusions in Example 4, the average diameter was set to 62.5 μm, the average height was set to 200 μm, and the average center interval was set to 125 μm.

For the micro protrusions in Example 5, the average diameter was set to 62.5 μm, the average height was set to 120 μm, and the average center interval was set to 50 μm.

For the micro protrusions in Example 6, the average diameter was set to 62.5 μm, the average height was set to 120 μm, and the average center interval was set to 200 μm.

On the other hand, at least one of the average diameters, the average heights, and the average center intervals in Comparative Examples 1 to 7 were outside the ranges of the micro protrusions in Examples 1 to 6.

Specifically, the micro protrusions in Comparative Examples 1 were different from those in Example 1 and Example 2 in that the average diameter was 30 μm, and the others were the same as those in Example 1 and Example 2.

The micro protrusions in Comparative Example 2 were different from those in Example 1 and Example 2 in that the average diameter was 95 μm, and the others were the same as those in Example 1 and Example 2.

The micro protrusions in Comparative Example 3 were different from those in Example 3 and Example 4 in that the average height was 30 μm, and the others were the same as those in Example 3 and Example 4.

The micro protrusions in Comparative Example 4 were different from those in Example 3 and Example 4 in that the average height was 210 μm, and the others were the same as those in Example 3 and Example 4.

The micro protrusions in Comparative Example 5 were different from those in Example 5 and Example 6 in that the average center interval was 40 μm, and the others were the same as those in Example 5 and Example 6.

The micro protrusions in Comparative Example 6 were different from those in Example 5 and Example 6 in that the average center interval was 210 μm, and the others were the same as those in Example 5 and Example 6.

The micro protrusions in Comparative Example 7 were different in that the micro protrusions were not regularly aligned but randomly aligned although the average diameter was 62.5 μm, the average height was 120 μm, and the average center interval was 125 μm.

### [Evaluation Criteria]

Evaluation results (touch feeling, pressure resistance, abrasion resistance) shown in Table 1 and Table 2 are based on the following indexes.

Evaluation of the “touch feeling” was a test for checking surface textures in Examples 1 to 6 and Comparative Examples 1 to 7. Touch feelings at the time of touch with fingers were tested, and the test results were evaluated in four levels.

As for the results of evaluating the “touch feeling”, a state in which the touch feeling at the time of touching with fingers was as smooth as a surface of natural leather was evaluated as “smooth”, a state in which the touch feeling at the time of touching with fingers was slippery with a feeling of flatness as compared with the surface of the natural leather was evaluated as “slippery”, a state in which the touch feeling at the time of touching with fingers was sticky with a feeling like rubber as compared with the surface of the natural leather was evaluated as “sticky”, and a state in which the touch feeling at the time of touching with fingers was rough with a sandy feeling as compared with the surface of the natural leather was evaluated as “rough”.

Evaluation of the “pressure resistance” was a test for checking presence/absence of degradation (restoring force) of the micro protrusions in Examples 1 to 6 and Comparative Examples 1 to 7. A smooth iron plate of 30 cm×30 cm was placed on each evaluation sample and was further left for 30 minutes with a load of 60.0 Kg uniformly applied thereto, and the surface state 5 minutes after the iron plate and the load were removed was checked. The test results were evaluated in three levels.

As for the results of evaluating the “pressure resistance”, evaluation was made such that A: there was no degradation of micro protrusion at all, B: there was substantially no degradation of micro protrusions, and C: there was degradation of micro protrusions.

Evaluation of the “abrasion resistance” was a test for checking presence/absence of abrasion (shaving) in the surfaces of the skin layers and the micro protrusions in Examples 1 to 6 and Comparative Examples 1 to 7 in which the surface treated layers were formed on the surfaces of the skin layers. A Gakushin-type abrasion tester defined by JIS L 0823 (abrasion tester for a color fastness test) was used to carry out an abrasion test 30,000 times in a reciprocated manner with a cotton canvas No. 6 of JIS L 3102 with a load of 0.5 Kg. Note that each evaluation sample with a surface treatment material applied thereto was used by attaching urethan foam with a width of 10 mm and a thickness of 5 mm thereto. The test results were evaluated in three levels.

As for the result of evaluating the “abrasion resistance”, evaluation was made such that A: abrasion was not noticeable after 30,000-time reciprocation, B: abrasion was observed after 20,000-time reciprocation, and C: the skin layer was broken after 20,000-time reciprocation.

As the “total evaluation”, comprehensive evaluation in three levels was made on the basis of the aforementioned results of evaluating “touch feeling”, “pressure resistance”, and “abrasion resistance”.

As for the evaluation result of the “total evaluation”, evaluation was made such that an example in which all the touch feeling, the pressure resistance, and the abrasion resistance were excellent was evaluated as “AA: optimal”, an example in which at least one of the touch feeling, the pressure resistance, and the abrasion resistance was slightly inferior but fell within an allowable range was evaluated as “A: good”, and an example in which at least one of the touch feeling, the pressure resistance, and the abrasion resistance was inferior and did not fall within the allowable range was evaluated as “C: not suitable”.

TABLE 1

| | | Examples | | | | | |
|---|---|---|---|---|---|---|---|
| | | 1 | 2 | 3 | 4 | 5 | 6 |
| Micro | Diameter (μm) | 40 | 85 | 62.5 | 62.5 | 62.5 | 62.5 |
| protrusions | Height (μm) | 120 | 120 | 40 | 200 | 120 | 120 |
| | Center interval | 125 | 125 | 125 | 125 | 50 | 200 |
| | (μm) | | | | | | |
| | Alignment | Regular | Regular | Regular | Regular | Regular | Regular |
| Evaluation | Touch feeling | Smooth | Smooth | Smooth | Smooth | Smooth | Smooth |
| result | Pressure resistance | A | A | A | A | A | B |
| | Abrasion resistance | A | A | A | A | A | B |
| | Total evaluation | AA | AA | AA | AA | AA | A |

TABLE 2

| | | Comparative Examples | | | | | | |
|---|---|---|---|---|---|---|---|---|
| | | 1 | 2 | 3 | 4 | 5 | 6 | 7 |
| Micro | Diameter | 30 | 95 | 62.5 | 62.5 | 62.5 | 62.5 | 62.5 |
| protrusions | (μm) | | | | | | | |
| | Height | 120 | 120 | 30 | 210 | 120 | 120 | 120 |
| | (μm) | | | | | | | |
| | Center | 125 | 125 | 125 | 125 | 40 | 210 | 125 |
| | interval | | | | | | | |
| | (μm) | | | | | | | |
| | Alignment | Regular | Regular | Regular | Regular | Regular | Regular | Random |
| Evaluation | Touch | Smooth | Rough | Sticky/ | Smooth | slippery | Rough | Rough |
| result | feeling | | | slippery | | | | |
| | Pressure | C | A | A | C | A | C | A |
| | resistance | | | | | | | |
| | Abrasion | C | A | A | C | A | C | A |
| | resistance | | | | | | | |
| | Total | C | C | C | C | C | C | C |
| | evaluation | | | | | | | |

### [Evaluation Results]

In comparison of Examples 1 to 6 and Comparative Examples 1 to 7, satisfactory evaluation results were obtained in terms of the touch feelings, the pressure resistance, and the abrasion resistance in Examples 1 to 6.

As is obvious from the evaluation results, it was possible to demonstrate that the synthetic resin leathers in Examples 1 to 6 provided smooth satisfactory touch feelings like a natural leather and had excellent abrasion resistance and pressure resistance.

Among these, since the average center interval of the micro protrusions (the top surface parts and the pillar sections) was relatively long, and the top surface parts and the pillar sections were likely to be elastically deformed due to contact with the user's hand, fingers, or the like in Example 6, the evaluation results were slightly inferior in terms of pressure resistance and abrasion resistance but fell within allowable ranges.

Therefore, it was possible to obtain optimal total evaluation in Examples 1 to 5, in particular, and it was possible to demonstrate that the synthetic resin leathers were closer to the natural leather.

However, on the other hand, not all of the results of evaluating the touch feelings, the pressure resistance, and the abrasion resistance were satisfactory in Comparative Examples 1 to 7.

More specifically, in Comparative Example 1, the average diameter of the micro protrusions (the top surface parts and the pillar sections) was excessively small, elastic deformation was achieved due to contact with the user's hand, fingers, or the like, the touch feeling was “smooth”, and satisfactory evaluation result was obtained. However, a result of evaluating the pressure resistance was dissatisfactory since the pillar sections were likely to be deformed in a collapsed manner due to a load, and also, a result of evaluating the abrasion resistance was also dissatisfactory since the top surface parts and the pillar sections were elastically deformed more than necessary due to contact with the user's hand, fingers, or the like.

In Comparative Example 2, the average diameter of the micro protrusions (the top surface parts and the pillar sections) was excessively large, the pillar sections were unlikely to be elastically deformed even when the user's hand, fingers, or the like touched the top surface parts, the touch feeling was thus “rough”, and the evaluation result was dissatisfactory.

In Comparative Example 3, the average height of the micro protrusions (the top surface parts and the pillar sections) was excessively low (relatively thick and short), the user's hand, fingers, or the like also touched the surface of the skin layer in a case where the top surface parts approached the surface of the skin layer as much as possible, the touch feeling was thus “sticky”, and the evaluation result was dissatisfactory. Moreover, in a case where the top surface parts did not approach the surface of the skin layer as much as possible, the pillar sections were unlikely to be elastically deformed even if the user's hand, fingers, or the like touched the top surface parts, the touch feeling was thus “slippery”, and the evaluation result was dissatisfactory.

In Comparative Example 4, the average height of the micro protrusions (top surface parts and the pillar sections) was excessively high (relatively thin and long), the pillar sections were likely to be deformed in a collapsed manner due to a load, the result of evaluating the pressure resistance was dissatisfactory. Furthermore, since the top surface parts and the pillar sections were elastically deformed more than necessary due to contact with the user's hand, fingers, or the like, the result of evaluating the abrasion resistance was also dissatisfactory.

In Comparative Example 5, the average center interval of the micro protrusions (the top surface parts and the pillar sections) was excessively short, the density of the micro protrusions with respect to the surface of the skin layer was high, the pillar sections were unlikely to be elastically deformed even when the user's hand, fingers, or the like touched the top surface parts, the touch feeling was thus “slippery.”, and the evaluation result was dissatisfactory.

In Comparative Example 6, the average center interval of the micro protrusions (top surface parts and the pillar sections) was excessively long, the density of the micro protrusions with respect to the surface of the skin layer was low, intermittent contact was achieved, the touch feeling was thus “rough”, and the evaluation result was dissatisfactory. Additionally, the result of evaluating the pressure resistance was dissatisfactory since the pillar sections were likely to be deformed in a collapsed manner due to a load, and also, the result of evaluating the abrasion resistance was also dissatisfactory since the top surface parts and the pillar sections were elastically deformed more than necessary due to contact with the user's hand, fingers, or the like.

In Comparative Example 7, the micro protrusions were irregularly (randomly) aligned, a feeling of sparseness and density of the micro protrusions with respect to the surface of the skin layer was also random at locations where the micro protrusions were not aligned, a partial touch feeling was thus “rough”, and the evaluation result was dissatisfactory.

Note that although the evaluation samples in which each of the large number of micro protrusions with prism shapes having planar top surface parts was intermittently and regularly (at a uniform interval in a staggered shape) aligned on the surfaces of the skin layers were evaluated in Examples 1 to 6 and Comparative Examples 1 to 6 described above, the present invention was not limited thereto, and evaluation results similar to those of Examples 1 to 6 were obtained even from evaluation samples in which a large number of micro protrusions with semispherical shapes having curved top surface parts were regularly (at a uniform interval in a staggered shape) aligned and evaluation samples in which a large number of micro protrusions with prism shapes or semispherical shapes were regularly (at a uniform interval in a lattice shape) aligned.

### REFERENCE SIGNS LIST

A, A1, A2 Synthetic resin leather
1 Base material
2 Skin layer
2a Surface
21 Micro protrusion
21a Top surface part
21b Pillar section
H Height (average height)
r Size (average diameter)
S Mutual interval (average center interval)

1. A synthetic resin leather comprising:
a base material; and
a skin layer that is stacked on the base material and is made of an elastically deformable synthetic resin, wherein
a large number of micro protrusions are intermittently and regularly provided on a surface of the skin layer, and
the large number of micro protrusions include a large number of top surface parts that are formed at substantially same height from the surface of the skin layer and a large number of pillar sections that are formed to be elastically deformable from the surface of the skin layer over the large number of top surface parts.

2. The synthetic resin leather according to claim 1, wherein the large number of micro protrusions are formed into prism shapes, in which the large number of top surface parts have planar shapes, or semispherical shapes, in which the large number of top surface parts have curved shapes.

3. The synthetic resin leather according to claim 1, wherein the large number of micro protrusions are set such that a ratio of a size, a height, and a mutual interval thereof is 2.0 to 4.3:2.0 to 10.0:2.5 to 10.0, and the mutual interval therebetween is longer than the size.

4. A method of manufacturing a synthetic resin leather, the method comprising:
a stacking step of providing a skin layer that is made of an elastically deformable synthetic resin on a base material; and
an embossing step of intermittently and regularly providing a large number of micro protrusions over an entire surface of the skin layer, wherein
in the embossing step, a large number of top surface parts that are formed at substantially same height from the surface of the skin layer and a large number of pillar sections that are formed to be elastically deformable from the surface of the skin layer over the large number of top surfaces are embossed as the large number of micro protrusions.

5. The synthetic resin leather according to claim 2, wherein the large number of micro protrusions are set such that a ratio of a size, a height, and a mutual interval thereof is 2.0 to 4.3:2.0 to 10.0:2.5 to 10.0, and the mutual interval therebetween is longer than the size.
